(19) United States
(12) Patent Application Publication
(10) Pub. No.: US 2025/0330065 A1
(43) Pub. Date: Oct. 23, 2025

(54) MOTOR HEAT DISSIPATION STRUCTURE

(71) Applicant: ANHUI ZHENG AIRCRAFT ELECTRICAL EQUIPMENT CO. , LTD., Xuancheng, Anhui (CN)

(72) Inventors: Hongfeng Ma, Xuancheng, Anhui (CN); Yunfei Yang, Xuancheng, Anhui (CN); Zhengquan Yang, Xuancheng, Anhui (CN)

(21) Appl. No.: 18/723,605

(22) PCT Filed: Nov. 28, 2022
(86) PCT No.: PCT/CN2022/134655

§ 371 Date: Jun. 30, 2025

(30) Foreign Application Priority Data
Nov. 21, 2022 (CN) 202211456917.3

(51) Int. Cl. H02K 9/19; H02K 5/20

(52) U.S. Cl. CPC H02K 9/19; H02K 5/203

(57) ABSTRACT

The present invention relates to the technical field of motor heat dissipation, and in particular, to a motor heat dissipation structure, including: a motor base and a motor housing provided on the motor base, where a stator is fixedly provided inside the motor housing, the motor housing is in bearing connection to an output shaft, and a rotor is fixedly sleeved on an outer race of the output shaft; an outer race of the stator is located between the motor housing and the stator and is provided with a housing, an air chamber in communication with atmosphere is formed between the stator and the housing, and the air chamber can transfer heat generated by the stator; the motor housing is provided with a water-cooling mechanism, and the heat of the air chamber is transferred to the water of water-cooling mechanism; and the stator is provided with a sensing mechanism for sensing the heat of the air chamber. In conclusion, according to the motor heat dissipation structure of the present application, when the heat generated by the motor is relatively high, the water flow rate can be adjusted based on the generated heat, the water flow rate can be automatically increased and the heat exchange between the air chamber and atmospheric air can be accelerated at the same time, thereby effectively preventing the motor from overheating, and improving the service life of the motor.

### TECHNICAL FIELD

The present invention relates to the technical field of motor heat dissipation, and in particular, to a motor heat dissipation structure.

### BACKGROUND

Generally, a structure of a motor mainly includes a stator, a rotor, and a structure component, etc., where the structure component includes a cooling fan, etc. When a current flows into a coil, the motor generates heat after continuously working. After the motor runs for a period of time and generates heat, the heat needs to be processed. In the existing motor, a rotor of the motor is generally used to drive a fan to rotate to dissipate heat, or air-cooling or water-cooling is used to dissipate heat. In these manners, heat of the motor can be dissipated, but there are also problems.

With regard to water-cooling heat dissipation, in the prior art, in order to prevent an excessive temperature rise at various parts of the motor, a special channel or a pipe filled with water is usually provided at the hottest part of the motor, and the circulating air inside the motor brings the internal heat to the surface cooled by the water, thereby achieving the purpose of water cooling.

Since the water-cooling heat dissipation cannot be adjusted effectively based on the heat generated by the motor, when the working time of the motor is short and the heat generated by the motor is low, the water-cooling working condition can meet the heat dissipation of the motor. However, when the working time of the motor is long and the heat generated by the motor is high, the stable water-cooling condition cannot meet the heat dissipation of the motor because the water-cooling condition cannot be adjusted, and as a result, a part of the heat cannot be absorbed effectively. Once the motor has been working for a long time, the motor is still overheated, or even the motor is damaged, thereby reducing the service life of the motor.

### SUMMARY

In view of this, according to an objective of the present invention, there is provided a motor heat dissipation structure to solve the problem that when the motor works, water-cooling heat dissipation cannot be adjusted effectively based on the heat generated by the motor, and when the heat generated by the motor exceeds a stable working condition, the motor is still overheated, or even the motor is damaged, thereby reducing the service life of the motor.

Based on the above objective, the present invention provides a motor heat dissipation structure, including: a motor base and a motor housing provided on the motor base, where a stator is fixedly provided inside the motor housing, the motor housing is in bearing connection to a driving shaft, and a rotor is fixedly sleeved on an outer race of the driving shaft;
an outer race of the stator is located between the motor housing and the stator and is provided with a housing, an air chamber in communication with atmosphere is formed between the stator and the housing, and the air chamber can transfer heat generated by the stator;
the motor housing is provided with a water-cooling mechanism, and the heat of the air chamber is transferred to the water of the water-cooling mechanism;
the stator is provided with a sensing mechanism for sensing the heat of the air chamber;
the water-cooling mechanism is provided with an adjusting mechanism electrically connected to the sensing mechanism, and the sensing mechanism controls the adjusting mechanism to adjust the flow of the water-cooling mechanism based on the heat value of the air chamber to match the heat generated by the stator; and
the motor housing is provided with a reciprocating mechanism in communication with the air chamber and electrically connected to the sensing mechanism, and the sensing mechanism is used to control the reciprocating mechanism to accelerate the air flow of the air chamber.

Preferably, the water-cooling mechanism includes a water tank and a water pump provided on the motor housing, an input end of the water pump is connected to an input pipe in communication with the water tank, an output end of the water pump is connected to an output pipe for taking away the heat, and the output pipe is in communication with the water tank after passing through the air chamber.

Preferably, the sensing mechanism includes a processor mounted on the motor housing, an outer race of the stator is sleeved with a thermosensitive element for sensing the heat of the air chamber, and the processor is electrically connected to the thermosensitive element.

Preferably, the adjusting mechanism includes a connection box provided on the motor housing and in communication with the output pipe, the connection box is mounted with an electric push rod I electrically connected to the processor, an output end of the electric push rod I is connected to a baffle plate, the baffle plate is slidably provided in the connection box, and the baffle plate is provided with several water leakage holes, where the number of water leakage holes correspondingly communicating with the output pipe is controlled based on the water flow rate of the output pipe.

Preferably, the top of the water tank is provided with several heat dissipation holes, an insulated funnel is provided inside the water tank, the funnel separates the water tank into an upper part and a lower part, the upper part is in communication with the output pipe, the water tank is provided with a stirring mechanism for stirring hot water of the upper part, the lower part is in communication with the input pipe, the funnel is provided with a flow-limiting mechanism for controlling the water of the upper part to flow into the lower part.

Preferably, the stirring mechanism includes an inflator mounted on the motor housing, an input end of the inflator is connected to a connection pipe that can be inserted into the water tank, the connection pipe is provided with several branch pipes, the branch pipe is provided with several air nozzles for ejecting gas to stir the water of the upper part.

Preferably, the flow-limiting mechanism includes a butterfly plate rotatably connected to the funnel, the butterfly plate is provided with a pressure sensing sheet, an electric push rod II is hinged to both sides of a rotation shaft on the butterfly plate, the other end of the electric push rod II is hinged to the funnel, the output directions of the two electric push rod II are opposite, and the processor is electrically connected to the pressure sensing sheet and the electric push rod II, where when the pressure sensing sheet senses the pressure of water on the butterfly plate, the processor collects pressure data of the pressure sensing sheet and controls the starting of the electric push rod II.

Preferably, the reciprocating mechanism includes a fixed block provided on the motor housing and a motor mounted on the fixed block, an air cylinder and an air outlet pipe in communication with the air chamber are provided on the housing, an output shaft of the motor is connected to a disk in bearing connection to the fixed block, a connecting rod is hinged to the disk at a position deviating from the center of circle, a movable rod is hinged to the other end of the connecting rod, an end of the movable rod is connected to a piston adapted to the air cylinder, the movable rod movably penetrates the air cylinder, and the processor is electrically connected to the motor.

Preferably, the output pipe includes several main pipes provided on the housing and wound around the periphery of the stator, an elbow pipe wound around the periphery of the stator is in communication between two adjacent main pipes, and the main pipes form a passage with the elbow pipe.

Preferably, a semiconductor chilling plate is mounted on the inner wall around the upper part of the water tank, and the semiconductor chilling plate is used for lowering a temperature of the water of the upper part.

The beneficial effects of the present invention are as follows: after a motor is started, a coil inside the stator generates heat, and a water-cooling mechanism is started; the water of the water-cooling mechanism passes through an air chamber, and the heat in the air chamber is taken away to exchange energy with the atmosphere; after the motor generates heat, a sensing mechanism senses the heat in the air chamber, collects heat data through the sensing mechanism, and controls an adjusting mechanism to start, so as to adjust the water flow rate of the water-cooling mechanism to match the heat generated by the stator; when the heat generated by the motor is relatively low, the working condition of the water-cooling mechanism can meet the heat dissipation of the motor; however, when the heat generated by the motor is relatively high and exceeds a certain heat value, the sensing mechanism is used to control the adjusting mechanism to adjust the water flow rate of the water-cooling mechanism to increase, and at the same time, the reciprocating mechanism is controlled to move by using the sensing mechanism, so that the air in the air chamber is forced to accelerate to flow, thereby effectively reducing the heat in the air chamber. In conclusion, according to a motor heat dissipation structure of the present application, when the heat generated by the motor is relatively high, the water flow rate of the water-cooling mechanism can be effectively adjusted based on the heat generated by the motor, the water flow rate can be automatically increased, and the heat exchange between the air chamber and atmospheric air can be accelerated, thereby effectively preventing the motor from overheating, facilitating the protection of the motor, and improving the service life of the motor.

### BRIEF DESCRIPTION OF DRAWINGS

In order to describe the technical solutions in the embodiments of the present invention or the prior art more clearly, the following briefly introduces the accompanying drawings required for describing the embodiments or the prior art. Apparently, the accompanying drawings in the following description show only some embodiments of the invention, and those of ordinary skill in the art may still derive other drawings from these drawings without any creative efforts.

FIG. 1 is a stereoscopic structural entity diagram of the present invention;

FIG. 2 is an exploded view of the present invention;

FIG. 3 is a stereoscopic half-section view of a reciprocating mechanism the present invention;

FIG. 4 is an enlarged view of A in FIG. 3 of the present invention;

FIG. 5 is a partial structural entity diagram of a reciprocating mechanism of the present invention;

FIG. 6 is a stereoscopic half-section view of a water tank of the present invention;

FIG. 7 is a structural entity diagram of a stirring mechanism of the present invention;

FIG. 8 is a structural entity diagram of a flow-limiting mechanism of the present invention;

FIG. 9 is a structural entity diagram of an adjusting mechanism of the present invention;

FIG. 10 is a stereoscopic half-section view of B in FIG. 9 of the present invention;

FIG. 11 is a partial structural entity diagram of an adjusting mechanism of the present invention; and

FIG. 12 is a structural entity diagram of an output pipe of the present invention.

Reference numerals in the figures: 1. motor base; 2. motor housing; 3. stator; 4. driving shaft; 5. rotor; 6. housing; 7 air chamber; 8. water-cooling mechanism; 801. water tank; 8011. heat dissipation hole; 802. water pump; 803. input pipe; 804. output pipe; 8041. main pipe; 8042. elbow pipe; 9. sensing mechanism; 901. processor; 902. thermosensitive element; 10. adjusting mechanism; 1001. connection box; 1002. electric push rod I; 1003. baffle plate; 1004. water leakage hole; 11. reciprocating mechanism; 1101. fixed block; 1102. motor; 1103. air cylinder; 1104. air outlet pipe; 1105. disk; 1106. connecting rod; 1107. movable rod; 1108. piston; 12. funnel; 13. stirring mechanism; 1301. inflator; 1302. connection pipe; 1303. branch pipe; 1304. air nozzle; 14. flow-limiting mechanism; 1401. butterfly plate; 1402. pressure sensing sheet; 1403. electric push rod II; and 15. semiconductor chilling plate.

### DETAILED DESCRIPTION OF THE EMBODIMENTS

To make the objectives, technical solutions and advantages of the present invention clearer, the present invention will be further described in detail below in conjunction with specific embodiments.

### Embodiment I

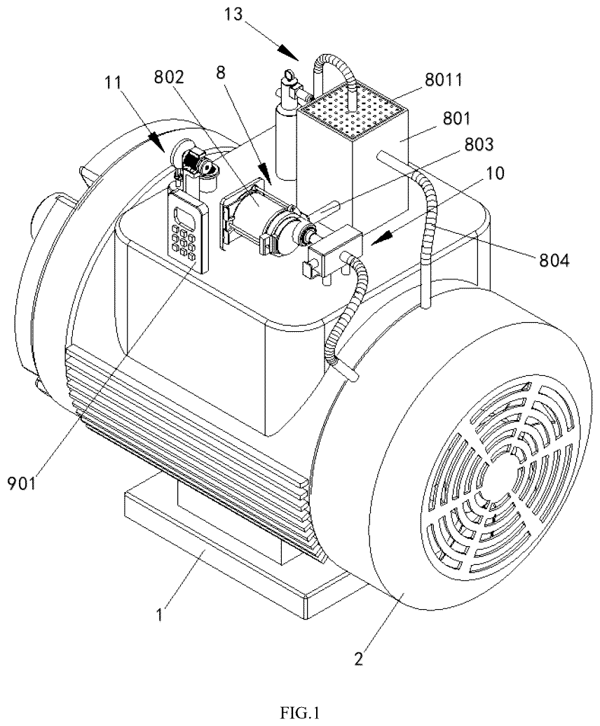

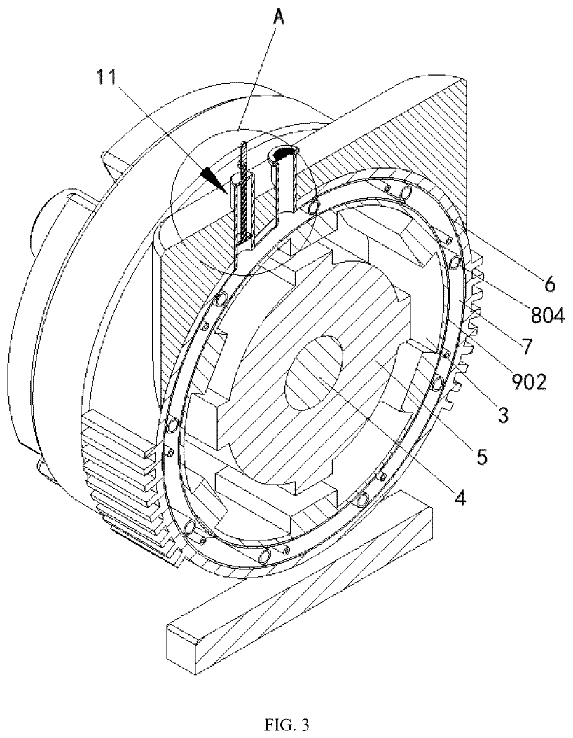

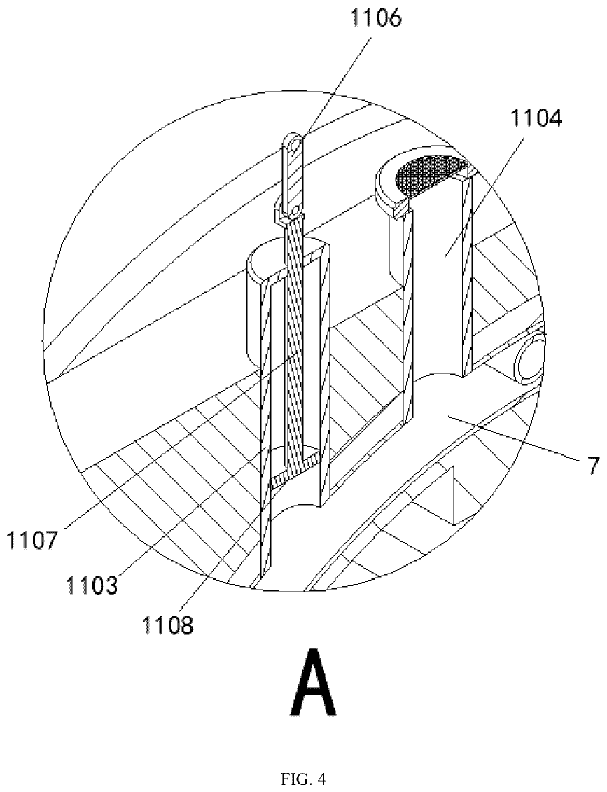

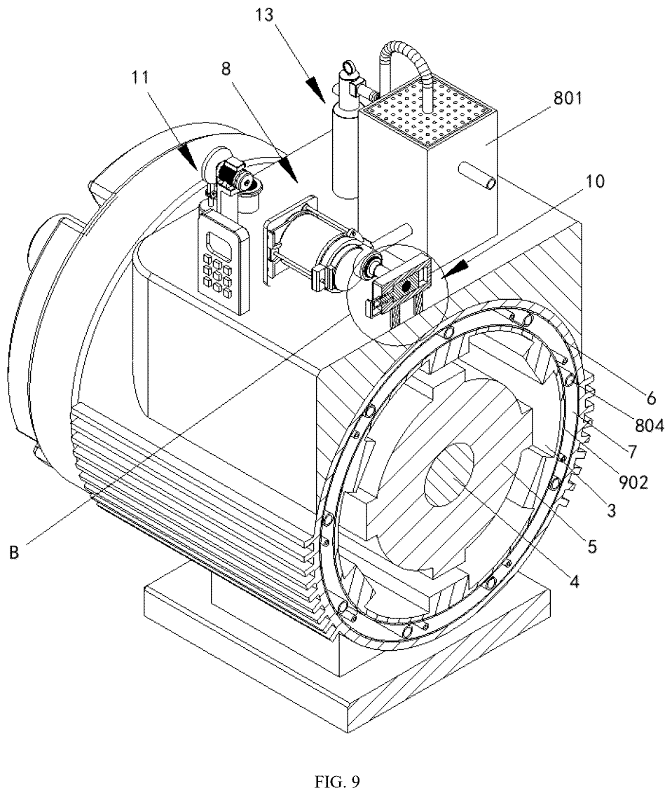

FIGS. 1, 2, 3, 4, 6, and 9 show a motor heat dissipation structure, including: a motor base 1 and a motor housing 2 provided on the motor base 1, where a stator 3 is fixedly provided inside the motor housing 2, a coil for generating heat is provided inside the stator 3, the motor housing 2 is in bearing connection to a driving shaft, and a rotor 5 is fixedly sleeved on an outer race of the driving shaft 4 (here is a basic structure of the motor and is the prior art);
an outer race of the stator 3 is located between the motor housing 2 and the stator 3 and is provided with a housing 6, the housing 6 is fixed to the stator 3, an air chamber 7 in communication with atmosphere is formed between the stator 3 and the housing 6, and the air chamber 7 can transfer heat generated by the stator 3, and the air chamber 7 is in communication with the atmosphere for heat exchange;
the motor housing 2 is provided with a water-cooling mechanism 8, and the heat of the air chamber 7 is transferred to the water of the water-cooling mechanism 8;
the stator 3 is provided with a sensing mechanism 9 for sensing the heat of the air chamber 7;
the water-cooling mechanism 8 is provided with an adjusting mechanism 10 electrically connected to the sensing mechanism 9, and the sensing mechanism 9 controls the adjusting mechanism 10 to adjust the flow of the water-cooling mechanism 8 based on the heat value of the air chamber 7 to match the heat generated by the stator 3; and
the motor housing 2 is provided with a reciprocating mechanism 11 in communication with the air chamber 7 and electrically connected to the sensing mechanism 9, and the sensing mechanism 9 is used to control the reciprocating mechanism 11 to accelerate the air flow of the air chamber 7.

Working principle: after the motor is started, the coil inside the stator 3 generates heat, and the water-cooling mechanism 8 is started; the water of the water-cooling mechanism 8 passes through the air chamber 7, and the heat in the air chamber 7 is taken away to exchange energy with the atmosphere; after the motor generates heat, the sensing mechanism 9 senses the heat in the air chamber 7, collects heat data through the sensing mechanism 9, and controls the adjusting mechanism 10 to start, so as to adjust the water flow rate of the water-cooling mechanism 8 to match the heat generated by the stator 3; when the heat generated by the motor is relatively low, the working condition of the water-cooling mechanism 8 can meet the heat dissipation of the motor; however, when the heat generated by the motor is relatively high and exceeds a certain heat value, the sensing mechanism 9 is used to control the adjusting mechanism 10 to adjust the water flow rate of the water-cooling mechanism 8 to increase, and at the same time, the reciprocating mechanism 11 is controlled to move by using the sensing mechanism 9, so that the air in the air chamber 7 is forced to accelerate to flow, thereby effectively reducing the heat in the air chamber 7. In conclusion, according to a motor heat dissipation structure of the present application, when the heat generated by the motor is relatively high, the water flow rate of the water-cooling mechanism 8 can be effectively adjusted based on the heat generated by the motor, the water flow rate can be automatically increased, and the heat exchange between the air chamber 7 and atmospheric air can be accelerated, thereby effectively preventing the motor from overheating, facilitating the protection of the motor, and improving the service life of the motor.

### Embodiment II

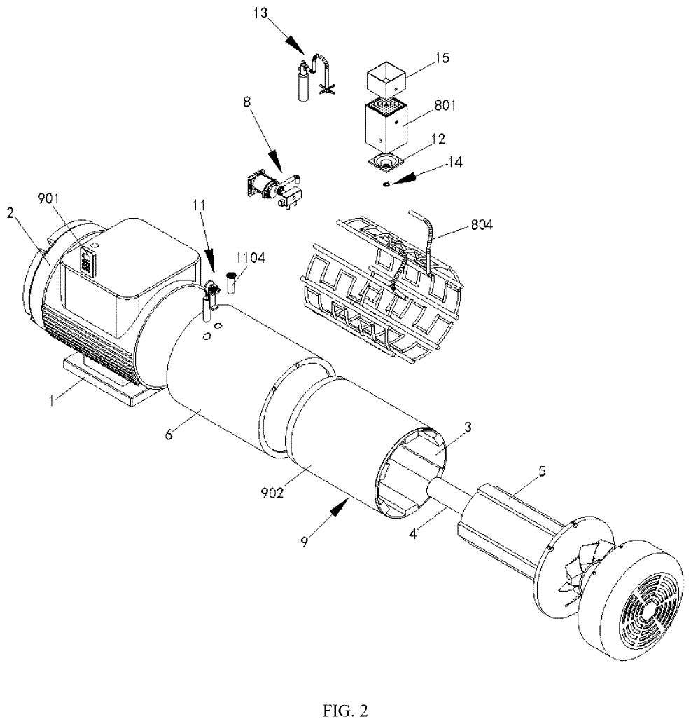

FIGS. 1 and 2 show a motor heat dissipation structure, where a water-cooling mechanism 8 includes a water tank 801 and a water pump 802 provided on a motor housing 2, an input end of the water pump 802 is connected to an input pipe 803 in communication with the water tank 801, an output end of the water pump 802 is connected to an output pipe 804 for taking away the heat, and the output pipe 804 is in communication with the water tank 801 after passing through an air chamber 7

FIGS. 1 and 2 show a motor heat dissipation structure, where a sensing mechanism 9 includes a processor 901 mounted on the motor housing 2, an outer race of a stator 3 is sleeved with a thermosensitive element 902 for sensing the heat of the air chamber 7, the thermosensitive element 902 is adapted to the stator 3, the processor 901 is electrically connected to the thermosensitive element 902, and the processor 901 can collect heat data of the thermosensitive element 902.

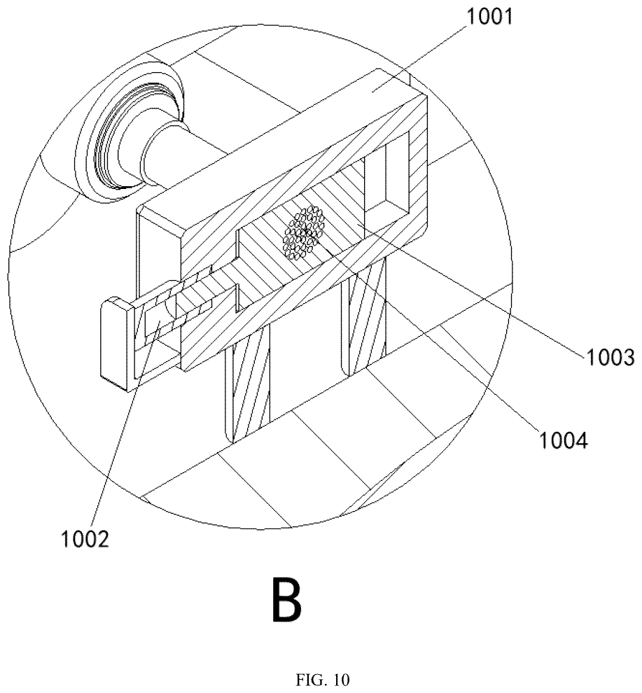

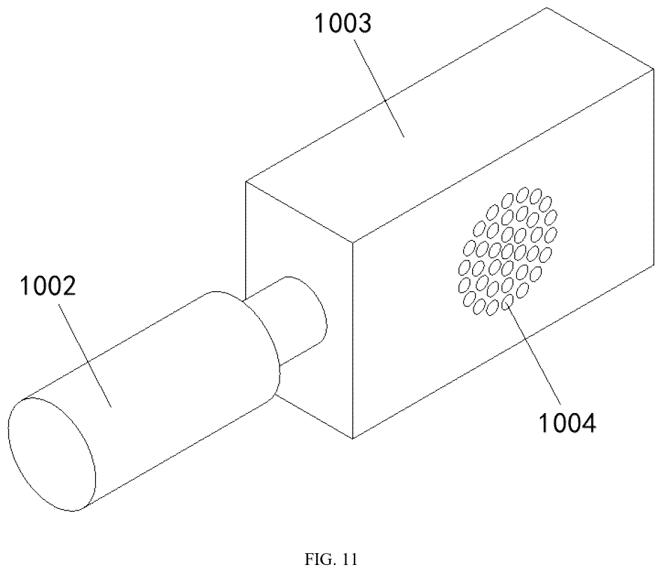

FIGS. 1, 9, 10, and 11 show a motor heat dissipation structure, where an adjusting mechanism 10 includes a connection box 1001 provided on the motor housing 2 and in communication with the output pipe 804, the connection box 1001 is mounted with an electric push rod I 1002 electrically connected to the processor 901, an output end of the electric push rod I 1002 is located inside the connection box 1001, the output end of the electric push rod I 1002 is connected to a baffle plate 1003, the baffle plate 1003 is slidably provided in the connection box 1001, the baffle plate 1003 can completely block the pipe diameter of the output pipe 804, and the baffle plate 1003 is provided with several water leakage holes 1004, where the number of water leakage holes 1004 correspondingly communicating with the output pipe 804 is controlled based on the water flow rate of the output pipe 804, and when the water flow rate increases, the number of water leakage holes 1004 correspondingly communicating with the output pipe 804 increases.

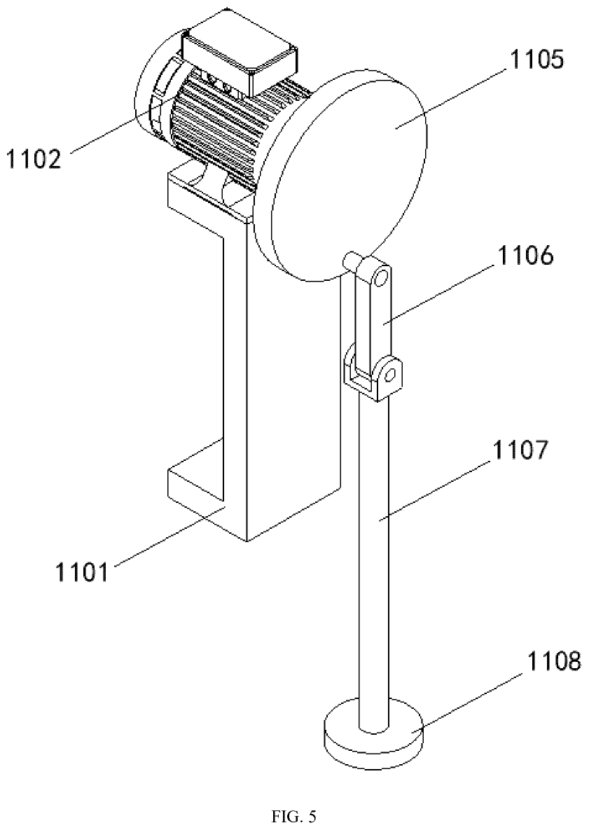

FIGS. 1, 2, 3, 4, and 5 show a motor heat dissipation structure, where a reciprocating mechanism 11 includes a fixed block 1101 provided on the motor housing 2 and a motor 1102 mounted on the fixed block 1101, an air cylinder 1103 and an air outlet pipe 1104 in communication with the air chamber 7 are provided on a housing 6, the other end of the air outlet pipe 1104 is in communication with the atmosphere, the air outlet pipe 1104 can be in and out of air, an output shaft of the motor 1102 is connected to a disk 1105 in bearing connection to the fixed block 1101, a connecting rod 1106 is hinged to the disk 1105 at a position deviating from the center of circle, a movable rod 1107 is hinged to the other end of the connecting rod 1106, an end of the movable rod 1107 is connected to a piston 1108 adapted to the air cylinder 1103, the piston 1108 is located inside the air cylinder 1103, the movable rod 1107 movably penetrates the air cylinder 1103, and the processor 901 is electrically connected to the motor 1102.

FIGS. 2, 3, and 12 show a motor heat dissipation structure, where the output pipe 804 includes several main pipes 8041 provided on the housing 6 and wound around the periphery of the stator 3, where the main pipes 8041 are provided along the length direction of the stator 3, an elbow pipe 8042 wound around the periphery of the stator 3 is in communication between two adjacent main pipes 8041, the elbow 8042 can increase the contact area between the output pipe 804 and the air in the air chamber 7, and the main pipes 8041 form a passage with the elbow pipe 8042.

Working principle: when the heat generated by the motor is relatively low, the water pump 802 is started, and the water in the water tank 801 is introduced into the output pipe 804 through the input pipe 803; when the water is introduced into the water tank 801 through the output pipe 804 to form a circulation, and the water passes through the output pipe 804 in the air chamber 7, the heat in the air chamber 7 is taken away, so as to reduce the temperature of the stator 3 of the motor, where when the water enters the air chamber 7, the water firstly enters the main pipe 8041 of the output pipe 804, then enters the elbow pipe 8042, circulates through the main pipe 8041 and the elbow pipe 8042, and then flows into the water tank 801; the alternating arrangement of the main pipe 8041 and the elbow pipe 8042 can increase the contact area between the output pipe 804 and the air in the air chamber 7, thereby improving the transfer of heat and improving the cooling effect; when the heat generated by the motor is relatively high, the thermosensitive element 902 senses the heat in the air chamber 7, and the processor 901 collects and analyzes the heat data of the thermosensitive element 902, when the heat reaches a certain value, the processor 901 controls an electric push rod I 1002 to start, and an output end of the electric push rod I 1002 drives the baffle plate 1003 to move in a connection box 1001, forcing the number of the water leakage holes 1004 in communication with the output pipe 804 to be increased, thereby increasing the water flow rate, so that the output pipe 804 takes away more heat; at the same time, the processor 901 controls a motor 1102 to start, an output shaft of the motor 1102 rotates to drive a disk 1105 to rotate, so that a connecting rod 1106 follows the disk 1105 to perform an eccentric motion, and the connecting rod 1106 drives a movable rod 1107 to reciprocate up and down in an air cylinder 1103, forcing a piston 1108 to reciprocate up and down in the air cylinder 1103, where when the piston 1108 moves downwards, the volume in the air chamber 7 is compressed, so that hot air is discharged from an air outlet pipe 1104; and when the piston 1108 moves upwards, the volume in the air chamber 7 is expanded, and cold air is sucked from the air outlet pipe 1104, so as to achieve the effect of rapidly exchanging heat between the air and the air chamber 7; with the cooperation of the water-cooling mechanism 8, the sensing mechanism 9, the adjusting mechanism 10 and the reciprocating mechanism 11, the water flow rate of the water-cooling mechanism 8 can be effectively adjusted based on the heat generated by the motor, and the water flow rate can be automatically increased by the adjusting mechanism 10, the reciprocating mechanism 11 can accelerate the heat exchange between the air chamber 7 and atmospheric air, thereby effectively preventing the motor from overheating, facilitating the protection of the motor, and improving the service life of the motor.

### Embodiment III

FIGS. 1, 2, 3, 4, 6, and 9 show a motor heat dissipation structure, including: a motor base 1 and a motor housing 2 provided on the motor base 1, where a stator 3 is fixedly provided inside the motor housing 2, a coil for generating heat is provided inside the stator 3, the motor housing 2 is in bearing connection to a driving shaft 4, and a rotor 5 is fixedly sleeved on an outer race of the driving shaft 4;
an outer race of the stator 3 is located between the motor housing 2 and the stator 3 and is provided with a housing 6, the housing 6 is fixed to the stator 3, an air chamber 7 in communication with atmosphere is formed between the stator 3 and the housing 6, and the air chamber 7 can transfer heat generated by the stator 3, and the air chamber 7 is in communication with the atmosphere for heat exchange;
the motor housing 2 is provided with a water-cooling mechanism 8, and the heat of the air chamber 7 is transferred to the water of the water-cooling mechanism 8;
the stator 3 is provided with a sensing mechanism 9 for sensing the heat of the air chamber 7;
the water-cooling mechanism 8 is provided with an adjusting mechanism 10 electrically connected to the sensing mechanism 9, and the sensing mechanism 9 controls the adjusting mechanism 10 to adjust the flow of the water-cooling mechanism 8 based on the heat value of the air chamber 7 to match the heat generated by the stator 3; and
the motor housing 2 is provided with a reciprocating mechanism 11 in communication with the air chamber 7 and electrically connected to the sensing mechanism 9, and the sensing mechanism 9 is used to control the reciprocating mechanism 11 to accelerate the air flow of the air chamber 7.

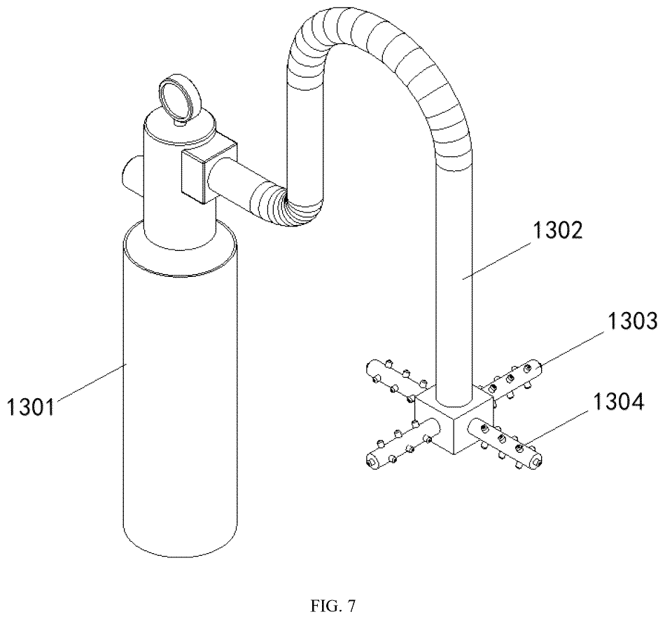

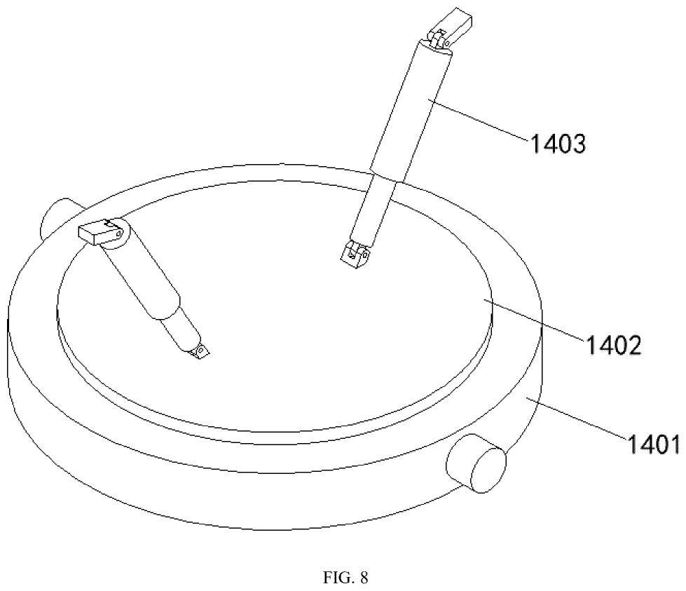

FIGS. 1, 2, 6, 7 and 8 show a motor heat dissipation structure, where the top of a water tank 801 is provided with several heat dissipation holes 8011, the heat dissipation holes 8011 can accelerate the heat exchange with the atmosphere, an insulated funnel 12 is provided inside the water tank 801, a water outlet end of the funnel 12 is provided as a cylindrical outlet, the funnel 12 separates the water tank 801 into an upper part and a lower part, the upper part is in communication with the output pipe 804, the water tank 801 is provided with a stirring mechanism 13 for stirring hot water of the upper part, the lower part is in communication with the input pipe 803, the funnel 12 is provided with a flow-limiting mechanism 14 for controlling the water of the upper part to flow into the lower part.

FIGS. 2, 6, and 7 show a motor heat dissipation structure, where the stirring mechanism 13 includes an inflator 1301 mounted on the motor housing 2, an input end of the inflator 1301 is connected to a connection pipe 1302 that can be inserted into the water tank 801, the connection pipe 1302 is provided with several branch pipes 1303, the branch pipe 1303 is in communication with the connection pipe 1302, and the branch pipe 1303 is provided with several air nozzles 1304 for ejecting gas to stir the water of the upper part, thereby accelerating heat dissipation of the water.

FIGS. 2, 6, and 8 show a motor heat dissipation structure, where the flow-limiting mechanism 14 includes a butterfly plate 1401 rotatably connected to the funnel 12, the butterfly plate 1401 is located at the cylindrical outlet, the butterfly plate 1401 is provided with a pressure sensing sheet 1402, in a water tank 801, because the higher the height of water, the greater the pressure generated, the pressure sensing sheet 1402 can sense the pressure of the water, an electric push rod II 1403 is hinged to both sides of a rotation shaft on the butterfly plate 1401, the other end of the electric push rod II 1403 is hinged to the funnel 12, the output directions of the two electric push rod II 1403 are opposite, and the processor 901 is electrically connected to the pressure sensing sheet 1402 and the electric push rod II 1403, where when the pressure sensing sheet 1402 senses the pressure of water on the butterfly plate 1401, the processor 901 collects pressure data of the pressure sensing sheet 1402 and controls the starting of the electric push rod II 1403.

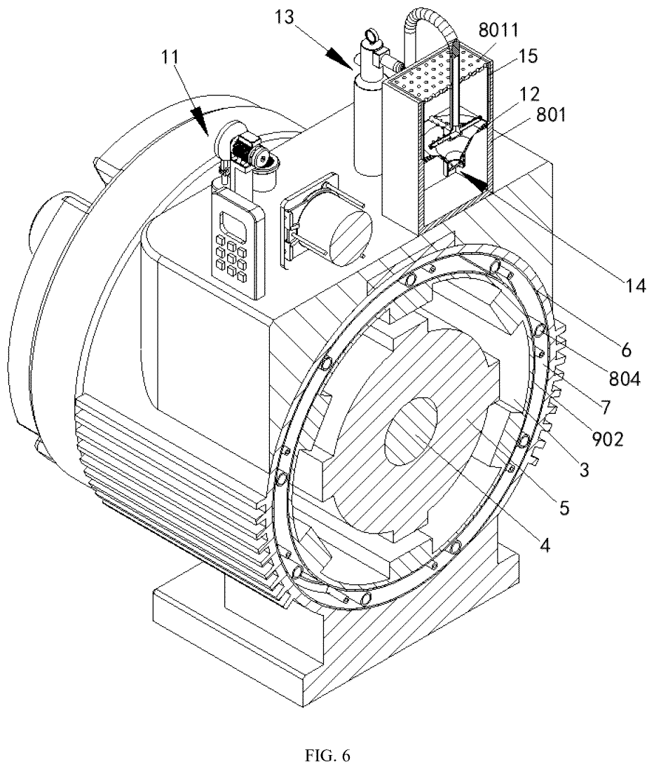

FIGS. 2 and 6 show a motor heat dissipation structure, where a semiconductor chilling plate 15 is mounted on the inner wall around the upper part of the water tank 801, the semiconductor chilling plate 15 can lower the temperature after being powered on (this is the prior art), and the semiconductor chilling plate 15 is used for lowering a temperature of the water of the upper part.

Working principle: when water enters the water tank 801 through the output pipe 804, the water in the output pipe 804 passes through the air chamber 7, due to transfer effect, the water temperature rises when the water enters the water tank 801, that is, the water temperature of the water entering the water tank 801 is relatively high; when the water enters the upper part of the water tank 801, the funnel 12 can thermally insulate the water of the upper part, the water flow continues to accumulate, the inflator 1301 is started, so that the inflator 1301 inflates the connection pipe 1302, the branch pipe 1303 and the air nozzle 1304 enable the air to eject under the water, the upper part of the water body is stirred, the heat is accelerated to be discharged through the heat dissipation holes 8011, and the heat dissipation capability of the water body is improved; at the same time, under the effect of the semiconductor chilling plate 15 around the water tank 801, the temperature of the water of the upper part is reduced; when the water continuously increases, a relatively large water pressure may be generated and act on the butterfly plate 1401, and when the water pressure is sensed by the pressure sensing sheet 1402, the processor 901 collects water pressure data; when the water pressure exceeds a certain value, the processor 901 controls the electric push rod II 1403 to move, and one electric push rod II 1403 elongates, the other electric push rod II 1403 shortens, and because the butterfly plate 1401 is rotatably connected to the funnel 12, the butterfly plate 1401 rotates, so that a gap is formed between the butterfly plate 1401 and the funnel 12, and at this time, water with a reduced temperature will flow into a lower part of the water tank 801 from the gap; when the pressure sensing sheet 1402 senses that the water pressure decreases to a certain value, the processor 901 collects the water pressure data to be relatively small, so that the processor 901 controls the electric push rod II 1403 to move to an original position, so that the butterfly plate 1401 moves to the original position and forms a seal with the funnel 12, and at this time, water cannot flow into the lower part, and the water will accumulate in the upper part after flowing into the water tank 801, and the operation is performed circularly in sequence; the water tank 801 is divided into two parts by using the funnel 12 and the flow-limiting mechanism 14, so that water with a temperature is restricted from flowing into the lower part; at the same time, the semiconductor chilling plate 15 and the stirring mechanism 13 are used to process water with a temperature, so that the heat dissipation of water is accelerated, and the temperature of water of the upper part is reduced; and at the same time, after the water temperature is reduced, the flow-limiting mechanism 14 can release the water of the upper part, thereby flowing into the lower part.

1. A motor heat dissipation structure, comprising: a motor base (1) and a motor housing (2) provided on the motor base (1), wherein a stator (3) is fixedly provided inside the motor housing (2), the motor housing (2) is in bearing connection to a driving shaft (4), and a rotor (5) is fixedly sleeved on an outer race of the driving shaft (4);
an outer race of the stator (3) is located between the motor housing (2) and the stator (3) and is provided with a housing (6), an air chamber (7) in communication with atmosphere is formed between the stator (3) and the housing (6), and the air chamber (7) can transfer heat generated by the stator (3);
the motor housing (2) is provided with a water-cooling mechanism (8), and the heat of the air chamber (7) is transferred to the water of the water-cooling mechanism (8);
the stator (3) is provided with a sensing mechanism (9) for sensing the heat of the air chamber (7);
the water-cooling mechanism (8) is provided with an adjusting mechanism (10) electrically connected to the sensing mechanism (9), and the sensing mechanism (9) controls the adjusting mechanism (10) to adjust the flow of the water-cooling mechanism (8) based on the heat value of the air chamber (7) to match the heat generated by the stator (3); and
the motor housing (2) is provided with a reciprocating mechanism (11) in communication with the air chamber (7) and electrically connected to the sensing mechanism (9), and the sensing mechanism (9) is used to control the reciprocating mechanism (11) to accelerate the air flow of the air chamber (7).

2. The motor heat dissipation structure according to claim 1, wherein the water-cooling mechanism (8) comprises a water tank (801) and a water pump (802) provided on the motor housing (2), an input end of the water pump (802) is connected to an input pipe (803) in communication with the water tank (801), an output end of the water pump (802) is connected to an output pipe (804) for taking away the heat, and the output pipe (804) is in communication with the water tank (801) after passing through the air chamber (7).

3. The motor heat dissipation structure according to claim 1, wherein the sensing mechanism (9) comprises a processor (901) mounted on the motor housing (2), an outer race of the stator (3) is sleeved with a thermosensitive element (902) for sensing the heat of the air chamber (7), and the processor (901) is electrically connected to the thermosensitive element (902).

4. The motor heat dissipation structure according to claim 3, wherein the adjusting mechanism (10) comprises a connection box (1001) provided on the motor housing (2) and in communication with the output pipe (804), the connection box (1001) is mounted with an electric push rod I (1002) electrically connected to the processor (901), an output end of the electric push rod I (1002) is connected to a baffle plate (1003), the baffle plate (1003) is slidably provided in the connection box (1001), and the baffle plate (1003) is provided with several water leakage holes (1004), wherein the number of water leakage holes (1004) correspondingly communicating with the output pipe (804) is controlled based on the water flow rate of the output pipe (804).

5. The motor heat dissipation structure according to claim 2, wherein the top of the water tank (801) is provided with several heat dissipation holes (8011), an insulated funnel (12) is provided inside the water tank (801), the funnel (12) separates the water tank (801) into an upper part and a lower part, the upper part is in communication with the output pipe (804), the water tank 801 is provided with a stirring mechanism (13) for stirring hot water of the upper part, the lower part is in communication with the input pipe (803), the funnel (12) is provided with a flow-limiting mechanism (14) for controlling the water of the upper part to flow into the lower part.

6. The motor heat dissipation structure according to claim 5, wherein the stirring mechanism (13) comprises an inflator (1301) mounted on the motor housing (2), an input end of the inflator (1301) is connected to a connection pipe (1302) that can be inserted into the water tank (801), the connection pipe (1302) is provided with several branch pipes (1303), and the branch pipe (1303) is provided with several air nozzles (1304) for ejecting gas to stir the water of the upper part.

7. The motor heat dissipation structure according to claim 5, wherein the flow-limiting mechanism (14) comprises a butterfly plate (1401) rotatably connected to the funnel (12), the butterfly plate (1401) is provided with a pressure sensing sheet (1402), an electric push rod II (1403) is hinged to both sides of a rotation shaft on the butterfly plate (1401), the other end of the electric push rod II (1403) is hinged to the funnel (12), the output directions of the two electric push rod II (1403) are opposite, and the processor (901) is electrically connected to the pressure sensing sheet (1402) and the electric push rod II (1403), wherein when the pressure sensing sheet (1402) senses the pressure of water on the butterfly plate (1401), the processor (901) collects pressure data of the pressure sensing sheet (1402) and controls the starting of the electric push rod II (1403).

8. The motor heat dissipation structure according to claim 1, wherein the reciprocating mechanism (11) comprises a fixed block (1101) provided on the motor housing (2) and a motor (1102) mounted on the fixed block (1101), an air cylinder (1103) and an air outlet pipe (1104) in communication with the air chamber (7) are provided on the housing (6), an output shaft of the motor (1102) is connected to a disk (1105) in bearing connection to the fixed block (1101), a connecting rod (1106) is hinged to the disk (1105) at a position deviating from the center of circle, a movable rod (1107) is hinged to the other end of the connecting rod (1106), an end of the movable rod (1107) is connected to a piston (1108) adapted to the air cylinder (1103), the movable rod (1107) movably penetrates the air cylinder (1103), and the processor (901) is electrically connected to the motor (1102).

9. The motor heat dissipation structure according to claim 2, wherein the output pipe (804) comprises several main pipes (8041) provided on the housing (6) and wound around the periphery of the stator (3), an elbow pipe (8042) wound around the periphery of the stator (3) is in communication between two adjacent main pipes (8041), and the main pipes (8041) form a passage with the elbow pipe (8042).

10. The motor heat dissipation structure according to claim 5, wherein a semiconductor chilling plate (15) is mounted on the inner wall around the upper part of the water tank (801), and the semiconductor chilling plate (15) is used for lowering a temperature of the water of the upper part.
